(19) United States
(12) Patent Application Publication
(10) Pub. No.: US 2004/0170484 A1
(43) Pub. Date: Sep. 2, 2004

(54) Striking plug

(76) Inventor: Fabrice Pourtier, Portes-les-Valence (FR)

Correspondence Address: LOWE, HAUPTMAN, GILMAN & BERNER, LLP (ITW), 1700 DIAGONAL ROAD, SUITE 300, ALEXANDRIA, VA, 22314, US

(21) Appl. No.: 10/736,981

(22) Filed: Dec. 17, 2003

(30) Foreign Application Priority Data
Dec. 18, 2002 (FR) 02 16096

(51) Int. Cl. F16B 1/00

(52) U.S. Cl. 411/57.1

(57) ABSTRACT

The plug comprises a tubular hollow body (3) surmounted by a bearing collar (2) with

a crural expansion part (20) with two slots (21) lying in an axial plane,

an intermediate expansion part (30) with a cut-away wall between the crural part (20) and the bearing collar (2).

The wall of the intermediate expansion part (20) is pierced, substantially in the extension of each slot (21, 21′) of the crural part (20), with a non-straight continuous expansion aperture (31) lying on either side of the said axial plane and axially spaced (22) from the said slot (21) in order to provide double axial expansion of the plug.

The present invention relates to a plug called a striking plug

Such a plug has the advantage of being simple to fit through the part to be fastened to the support material, by drilling an anchoring hole through the part and into the support, by inserting the plug therein, still through the part, until the collar of the plug comes into abutment against the part then presses against the support, by inserting a nail into the plug, which nail is struck using a tool in order to bring about the expansion and anchorage of the plug and therefore the fastening of the part to the support. The nail may subsequently be “unscrewed” in order to take it out of the plug.

It will be emphasized that the element for fastening a striking plug is a nail and not a screw, even if the nail is provided with a thread. This is because this thread is not shaped for screwing, but only for unscrewing.

A striking plug can be used in all types of material, such as concrete, solid breeze block, solid brick, hollow breeze block, hollow brick and filler block.

A striking plug has a tubular hollow body surmounted by a bearing collar, with a crural expansion part whose outer surface may have catching means, which is slotted in an axial plane. Thus the plug comprises two diametral longitudinal slots which are symmetrical with respect to its axis for its expansion. As a result, it may happen that, following poor striking or poor insertion of the nail in the plug, the nail is deflected and driven into one of the slots, to the detriment of proper expansion. This is the drawback of striking plugs.

Document FR 2 470 279 discloses a plug of a type which is somewhat similar, but which is however not a striking plug. Below the crural expansion part with symmetrical diametral longitudinal slots, the plug of this prior art comprises an intermediate expansion part, in the wall of which are made recesses, and which provides better guiding of a screw. However, the expansion of this intermediate part may be hindered as a result of the plurality of these recesses which, incidentally, extend symmetrically with respect to the axial plane of the slots of the crural part. Thus, inserting the screw causes not so much the expansion of this intermediate part as its bulging.

The invention of the present application aims to provide a striking plug ensuring, with proper and long guiding of the nail, better expansion on insertion of the nail.

To this end, the invention relates to a striking plug comprising a tubular hollow body surmounted by a bearing collar with

a crural expansion part with two slots lying in an axial plane,

an intermediate expansion part with a cut-away wall between the crural part and the bearing collar,

characterized in that the wall of the intermediate expansion part is pierced, substantially in the extension of each slot of the crural part, with a non-straight continuous expansion aperture lying on either side of the said axial plane and axially spaced from the said slot in order to provide double axial expansion of the plug.

In the plug of the invention, the axial length of the expansion apertures of the intermediate part may be shorter than that of the slots of the crural part.

Advantageously, the expansion apertures of the intermediate part lie in a zigzag. Advantageously again, the branches forming the zigzag of the expansion aperture form acute angles between them.

Preferably, each expansion aperture of the intermediate part is extended in its portion close to the bearing collar, by a side branch intended to reduce the risk of tearing at the start of expansion.

Preferably again, each expansion aperture of the intermediate part forms at least one retaining lug projecting out of the wall of the plug.

Still preferably, the surface of the inner bore of the plug, close to the bearing collar, is shaped in order to present a bead for retaining an expansion nail.

In another embodiment of the plug of the invention, two axially offset lugs are provided projecting out of the outer surface of the plug.

The invention will be better understood with the help of the following description of the preferred embodiment of the plug of the invention, with reference to the appended drawing, in which:

FIG. 1 shows a perspective view of a first embodiment of the plug of the invention and of a nail;

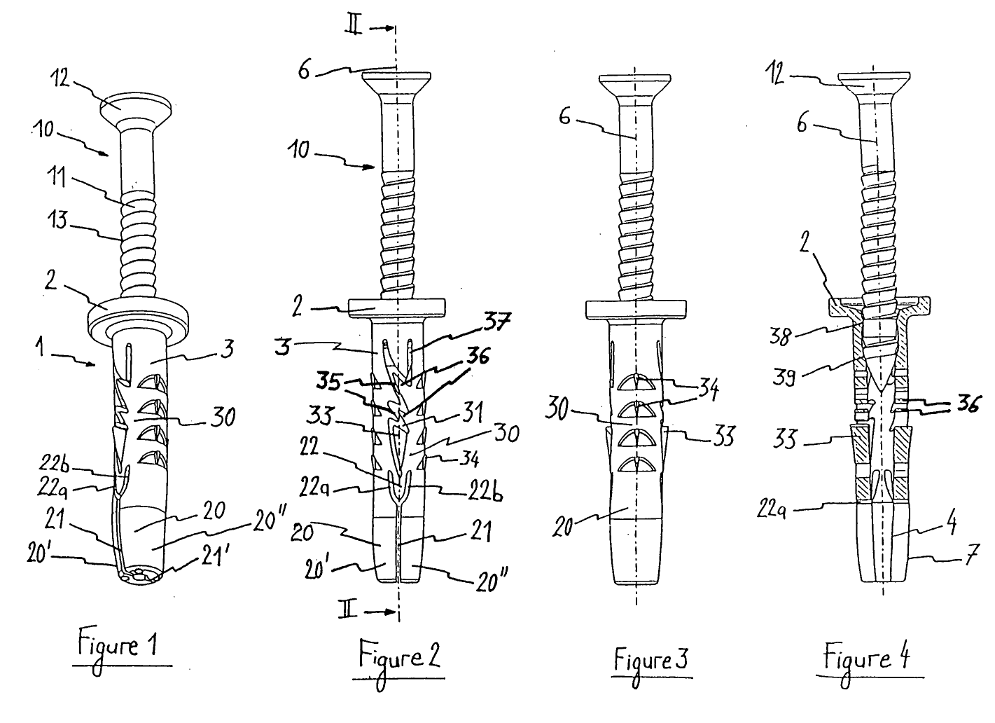

FIG. 2 shows a profile view of the plug and of the nail of FIG. 1;

FIG. 3 shows a profile view of the plug and of the nail of FIG. 2, rotated through 90° with respect to that of FIG. 2;

FIG. 4 shows a view of the nail and a sectional view of the plug along the axis II-II of FIG. 2;

FIG. 5 shows a perspective view of another embodiment of the plug of the invention;

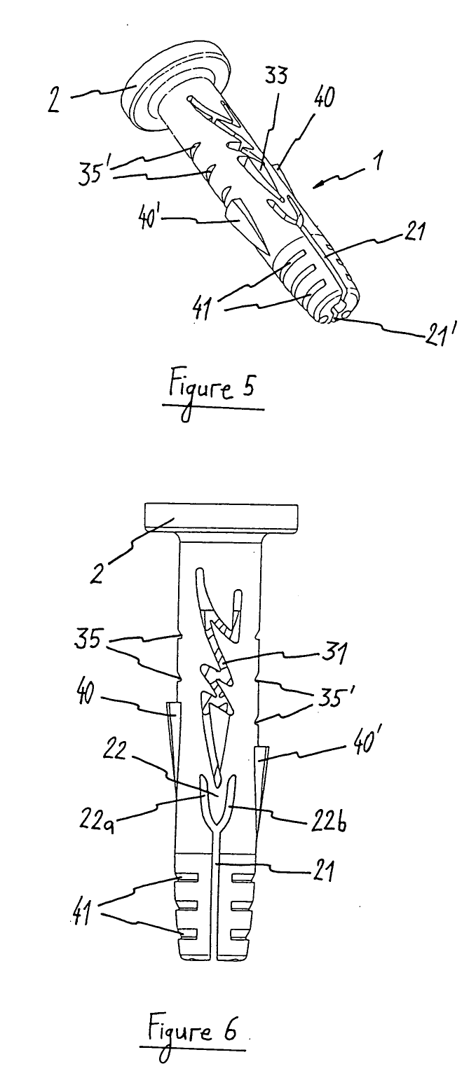

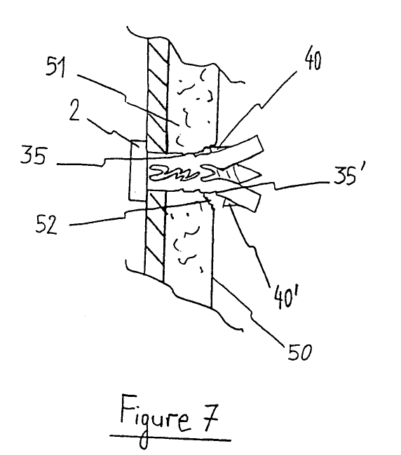

FIG. 6 shows a profile view of the plug of FIG. 5 and

FIG. 7 shows an outline diagram of the behaviour of the plug of FIG. 5 in a hollow support.

With reference to FIGS. 1 and 2, the plug 1 of the invention comprises a tubular body 3, extending along an axis 6, surmounted by a bearing collar 2. A nail 10 is inserted into the plug 1. This plug 1 is used for nails 10 comprising a head 12 and a shank 11, this shank 11 comprising a thread 13, which is shaped to allow the nail 10 to be pushed in by striking it, thus at the same time allowing the unscrewing of the nail 10.

The tubular body 3 of the plug 1 has a crural expansion part 20 and an intermediate part 30 between the crural expansion part 20 and the bearing collar 2. The crural expansion part 20 is split along a plane containing the axis 6; it therefore comprises two slots (20, 21′) which divide it into two half-bodies (20′, 20″).

In the rest of the description, we will systematically speak of “each slot (21, 21′)”, but will only detail the other elements with respect to the slot 21, it being understood that the plug 1 is perfectly symmetrical with respect to the axis 6 and therefore that each element described in that part of the plug 1 containing the slot 21 will have its symmetrical counterpart in that part of the plug 1 containing the slot 21′.

In the upper part of the crural expansion part 20, each slot (21, 21′) divides into two slots (22a, 22b) which lie symmetrically with respect to the axis of the slot (21, 21′) from which they start, over the axisymmetric surface of a plug 1. Each slot (21, 21′), continuously extended by its two slots (22a, 22b), therefore has a symmetrical Y shape. With reference to FIG. 4, the inner bore 4 of the crural expansion part 20 has a slightly frustoconical shape, narrowing towards the end, and with a diameter less than that of the shank of the nail 10. The outer surface 7 also has a slightly bulging frustoconical shape.

With reference to FIG. 2, the intermediate expansion part 30 of the plug 1 comprises a recessed wall in which an expansion aperture 31 is pierced, substantially in the extension of each slot (21, 21′) of the crural part 20. With reference to FIG. 3, the outer surface of this intermediate part 30 comprises catching lugs 34, of which there are eight in this case, distributed symmetrically four by four with respect to the axial plane containing the two slots (21, 21′) of the crural expansion part 20; each of the series of four lugs 34 are in line, the lugs 34 being mutually offset longitudinally.

The intermediate part 30 is overall a tubular body of substantially cylindrical shape having an axis 6. Each expansion aperture 31 of the intermediate part 30 lies overall in a longitudinal direction, substantially in the extension of each slot (21, 21′) and therefore in a direction substantially parallel to the axis 6. Each expansion aperture 31 lies in a zigzag shape on either side of the axial plane comprising the two slots (21, 21′) of the crural expansion part 20. The successive branches 35 forming the zigzag of each expansion aperture 31 form acute angles between them; in this way, they provide, on the path of the nail 10 along this wall, obstacles 36 not allowing the nail 10 to engage in the apertures 31. The last two branches 35 of each aperture 31 before the crural expansion part 20 also make a catching lug 33 in the radial direction forming an obstacle for the support receiving the plug 1. Each catching lug 33 projects substantially perpendicularly out of the outer surface of the plug 1, at the intersection between the last two branches 35 of each expansion aperture 31, and its radial thickness decreases along each of the branches 35, the surface connecting these two branches 35 being substantially flat, which gives the catching lug 33 an overall trihedral shape.

The expansion aperture 31 of the plug 1 of the invention comprises, in its portion close to the bearing collar 2, a side branch 37, finishing at the same longitudinal level of the previous branch 35, so as to reduce the risk of the wall of the plug 1 tearing at the start of expansion, that is to say as the portion of the plug 1 close to the bearing collar 2 expands.

Each slot (21, 21′) of the crural expansion part 20 is spaced apart from the associated expansion aperture 31 which provides, between the two slots (22a, 22b) extending the slot (21, 21′) and the expansion aperture 31, an expansion region 22 in the plane of the slots (21, 21′).

The end of the shank 11 of the nail 10 away from the head 12 is initially placed in the upper part of the plug 1, that is to say through the bearing collar 2 and the start of the intermediate part 30, either by the user, or directly by the manufacturer of the plug 1. On the surface 4 of the inner bore of the plug 1, in the portion close to the bearing collar 2, a bead 38 for retaining the nail 10 is provided and a narrowing 39, also for retaining the nail 10, such as the retaining bead 38, is located between the bearing collar 2 and the narrowing 39. The nail 10 is therefore immobilized in translation along the axis 6 by the retaining bead 38 and the narrowing 39; thus, the user does not need to unite the nail 10 and the plug 1 when taking them. Furthermore, he may push the plug 1 into the support until the bearing collar 2 comes into abutment on the part to be fastened to the support, the narrowing 39 preventing the nail 10 from being pushed into the plug 1 and from causing its expansion before the said abutment. It is then possible to push the nail 10 in by striking it using a suitable tool, such as a hammer. In the intermediate part 30, the diameter of the inner bore 4 of the plug 1 is smaller than the diameter of the shank 11 of the nail 10.

The behaviour of the plug 1 on pushing in a nail 10 will now be described. Once the bearing collar 2 abuts on the part to be fastened to the support, the use of a tool for striking the nail 10 allows the nail 10 to pass beyond the narrowing 39 and to be pushed into the plug 1. When the nail 10 is pushed in, it can only be pushed in essentially along the axis 6 of the plug 1. This is because, in the intermediate part 30, if it deviates from its path, the obstacles 36 prevent it engaging in the expansion apertures 31. Because of the presence of the expansion aperture 31, the nail 10 causes the expansion of the plug 1, the diameter of the shank 11 of the nail 10 being greater than the inner bore 4 of the plug 1. Thus, as soon as the nail 10 passes into the intermediate part 30, the plug 1 starts its expansion and therefore its anchoring in the wall of the support, in particular by means of its catching lugs 34. Due to the side branch 37, the expansion of the intermediate part 30 does not cause the plug 1 to tear, at the portion of the expansion aperture 31 close to the bearing collar 2.

The passage of the nail 10 from the intermediate part 30 to the crural expansion part 20 causes the expansion, in the plane of the slots (21, 21′), of the corresponding expansion regions 22. These expansion regions 22 then project and form new catching lugs.

Continuing to push in the nail 10 causes the crural expansion part 20 to expand because of the slots (21, 21′). The plug 1 is then completely anchored, the plug having expanded both in the intermediate part 30, in the expansion region 22 and in the crural expansion part 20.

With reference to FIG. 5, and according to an embodiment of the plug of the invention, a different set of catching lugs can also be provided, in this case especially provided for fastening a part to a hollow support material. References of elements which have not changed, and those of the plug 1, are preserved in FIGS. 5 and 6. In this embodiment, two fairly large lugs (40, 40′) are provided, projecting out of the outer surface of the plug 1, one on each side of the plane containing the two slots (21, 21′) of the crural expansion part 20. These lugs (40, 40′) are axially offset. One (40) is located in the lower part of the intermediate part 30, at the catching lug 33 formed by the last two branches 35 of the expansion aperture 31, the other (40′) is located at the expansion region 22, made by the branches (22a, 22b) extending each slot (21, 21′). The eight catching lugs 34 have been replaced by grooves (35, 35′) in the intermediate part 30. There are two of these grooves on the side of the plug 1 where the lug 40 is closest to the bearing collar 2, and three on the other side. Finally, the crural expansion part 20 is also provided with grooves 41. These grooves 41 help the plug 1 to catch in the wall of the support to which it is desired to fasten the part.

With reference to FIG. 7, on expansion of the plug 1 in a hollow support, the presence of the lugs (40, 40′) allows the plug 1 to be anchored in the support, by being braced against the rear face 50 of the hollow support material 51, whatever its thickness or the size of the crater 52 formed on drilling. The grooves (35, 35′) also help anchoring. This plug 1 can also be used in a solid support. The grooves 41 are then involved in the anchoring.

1. Striking plug comprising a tubular hollow body (3) surmounted by a bearing collar (2) with
a crural expansion part (20) with two slots (21, 21′) lying in an axial plane,
an intermediate expansion part (30) with a cut-away wall between the crural part (20) and the bearing collar (2),
characterized in that the wall of the intermediate expansion part (20) is pierced, substantially in the extension of each slot (21, 21′) of the crural part (20), with a non-straight continuous expansion aperture (31) lying on either side of the said axial plane and axially spaced (22) from the said slot (21, 21′) in order to provide double axial expansion of the plug.

2. Plug according to claim 1, in which the axial length of the expansion apertures (31) of the intermediate part (30) is shorter than that of the slots (21, 21′) of the crural part (20).

3. Plug according to either of claims 1 and 2, in which the expansion apertures (31) of the intermediate part (30) lie in a zigzag.

4. Plug according to claim 3, in which the branches (35) forming the zigzag of the expansion aperture (31) form acute angles between them.

5. Plug according to one of claims 1 to 4, in which each expansion aperture (31) of the intermediate part (30) is extended in its portion close to the bearing collar (2), by a side branch (37) intended to reduce the risk of tearing at the start of expansion.

6. Plug according to one of claims 1 to 5, in which each expansion aperture (31) of the intermediate part (30) forms at least one retaining lug (33) projecting out of the wall of the plug.

7. Plug according to one of claims 1 to 6, in which the surface of the inner bore (4) of the plug, close to the bearing collar (2), is shaped in order to present at least one bead (38, 39) for retaining an expansion nail (10).

8. Plug according to one of claims 1 to 7, in which two axially offset lugs (40, 40′) are provided projecting out of the outer surface of the plug.
